(19) United States
(12) Patent Application Publication
(10) Pub. No.: US 2014/0292593 A1
(43) Pub. Date: Oct. 2, 2014

(54) MULTIBAND MIMO ANTENNA ASSEMBLIES OPERABLE WITH LTE FREQUENCIES

(71) Applicant: Laird Technologies, Inc., Earth City, MO (US)

(72) Inventors: Cheikh T. Thiam, Grand Blanc, MI (US); Ayman Duzdar, Holly, MI (US); Melissa Carolina Lugo Brito, Clarkston, MI (US); Hasan Yasin, Grand Blanc, MI (US)

(21) Appl. No.: 14/302,690

(22) Filed: Jun. 12, 2014

Related U.S. Application Data
(63) Continuation of application No. PCT/US2012/069850, filed on Dec. 14, 2012.
(60) Provisional application No. 61/570,534, filed on Dec. 14, 2011.

(51) Int. Cl. H01Q 1/27; H01Q 1/42; H01Q 21/28; H01Q 21/30

(52) U.S. Cl. CPC H01Q 1/27; H01Q 21/30; H01Q 1/42; H01Q 21/28
USPC 343/713; 343/893; 343/872

(57) ABSTRACT

According to various aspects, exemplary embodiments are disclosed herein of Multiple Input Multiple Output (MIMO) antenna assemblies operable over multiple frequency bands, including LTE (Long Term Evolution) frequencies (e.g., 4G, 3G, other LTE generation, B17 (LTE), LTE (700 MHz), etc.). In various embodiments, an antenna assembly generally includes a first or primary cellular antenna and a second or secondary cellular antenna. The first cellular antenna may be configured to be operable for both receiving and transmitting communication signals within one or more cellular frequency bands (e.g., LTE, etc.). The second cellular antenna may be configured to be operable for receiving communication signals within one or more cellular frequency bands (e.g., LTE, etc.). The antenna assembly may also include additional antennas for receiving satellite signals, such as satellite digital audio radio services (SDARS) signals and/or global positioning system (GPS) signals.

### CROSS-REFERENCE TO RELATED APPLICATION

This patent application is continuation of PCT International Application No. PCT/US2012/069850 filed Dec. 14, 2012 (published as WO 2013/090783 on Jun. 20, 2013), which, in turn, claims priority to and the benefit of U.S. provisional patent application No. 61/570,534 filed Dec. 14, 2011. The disclosures of the applications identified in this paragraph are incorporated herein by reference in their entirety.

### FIELD

The present disclosure generally relates to Multiple Input Multiple Output (MIMO) antenna assemblies operable over multiple frequency bands, including LTE (Long Term Evolution) frequencies (e.g., 4G, 3G, other LTE generation, B17 (LTE), LTE (700 MHz), etc.).

### BACKGROUND

This section provides background information related to the present disclosure which is not necessarily prior art.

There are numerous, varied wireless communication standards in existence today, many of which operate within different frequency bands. Examples include Wi-Fi, Global Positioning System (GPS), Broadband Personal Communications Service (PCS)/Global System for Mobile Communications 1900 (GSM1900), Universal Mobile Telecommunications System (UMTS)/Advanced Wireless Service (AWS), Amplified Modulated Phone Service (AMPS)/Global System for Mobile Communications 850 (GSM850), Amplitude Modulation (AM)/Frequency Modulation (FM) radio, Long Term Evolution (LTE), etc.

Antenna systems having one or more antennas may be installed to generally flat and/or metallic surfaces of the automobiles (e.g., to the roof, hood, trunk, etc.) for receiving different cellular frequencies and enabling cell phone users to communicate with, for example, other cell phone users. Typically, though, for a user to receive frequencies in more than one frequency band (e.g., based on more than one network standard, etc.), the antenna system includes multiple antennas configured to receive one or more of the desired frequency bands.

### SUMMARY

This section provides a general summary of the disclosure, and is not a comprehensive disclosure of its full scope or all of its features.

According to various aspects, exemplary embodiments are disclosed herein of Multiple Input Multiple Output (MIMO) antenna assemblies operable over multiple frequency bands, including LTE (Long Term Evolution) frequencies (e.g., 4G, 3G, other LTE generation, B17 (LTE), LTE (700 MHz), etc.). In an exemplary embodiment, an antenna assembly generally includes a first or primary cellular antenna and a second or secondary cellular antenna. The first cellular antenna may be configured to be operable for both receiving and transmitting communication signals within one or more cellular frequency bands (e.g., LTE, etc.). The second cellular antenna may be configured to be operable for receiving communication signals within one or more cellular frequency bands (e.g., LTE, etc.). The antenna assembly may also include additional antennas configured to be operable for receiving satellite signals, such as satellite digital audio radio services (SDARS) signals and/or global positioning system (GPS) signals.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an exploded perspective view of an antenna assembly according to an exemplary embodiment;

FIG. 2 is a perspective view of the antenna assembly shown in FIG. 1 after the components have been assembled and positioned underneath the radome (which is shown transparent for clarity);

FIG. 3 is a lower perspective view of the antenna assembly shown in FIG. 2;

FIG. 4 is a perspective view of an antenna assembly according to a second exemplary embodiment, which includes a monopole antenna element, an inverted F antenna (IFA), and first and second patch antennas;

FIG. 5 is another perspective view of the antenna assembly shown in FIG. 4, and also illustrating an exemplary radome;

FIG. 6 is an exploded perspective view of an antenna assembly according to a third exemplary embodiment;

FIG. 7 is a perspective view of the antenna assembly shown in FIG. 6 after the components have been assembled and positioned underneath the radome (which is shown transparent for clarity);

FIG. 8 is a lower perspective view of the antenna assembly shown in FIG. 7;

FIG. 9 is an exploded perspective view of an antenna assembly according to a fourth exemplary embodiment;

FIG. 10 is a perspective view of the antenna assembly shown in FIG. 9 after the components have been assembled and positioned underneath the radome (which is shown transparent for clarity); and

FIG. 11 is a lower perspective view of the antenna assembly shown in FIG. 10.

Corresponding reference numerals indicate corresponding parts throughout the several views of the drawings.

### DETAILED DESCRIPTION

Example embodiments will now be described more fully with reference to the accompanying drawings.

With the increased use of LTE (Long Term Evolution) frequencies (e.g., 4G, 3G, other LTE generation, B17 (LTE), LTE (700 MHz), etc.), the inventors hereof recognized the need for more integration of additional antennas with low correlation and low coupling in automotive antenna systems and assemblies. Accordingly, the inventors have disclosed herein exemplary embodiments of multiband MIMO antenna assemblies or systems operable over multiple frequency bands (e.g., LTE, etc.). Such exemplary embodiments include multiple cellular antennas in combination with satellite antennas (e.g., GPS antenna, SDARS antenna, etc.). In such exemplary embodiments, the correlation and coupling between the cellular antennas is low, which allows for relatively close spacing of the cellular antennas such that the additional cellular antenna does not considerably increase the overall size of the antenna assembly.

In various exemplary embodiments, an antenna assembly generally includes a first or primary cellular antenna and a second or secondary cellular antenna. The first cellular antenna is configured to be operable for both receiving and transmitting communication signals within one or more cellular frequency bands. The second cellular antenna is configured to be operable for receiving communication signals within one or more cellular frequency bands. The antenna assembly may also include additional satellite antennas for receiving satellite signals, such as satellite digital audio radio services (SDARS) signals (e.g., Sirius XM, etc.) and/or signals associated with determining location, such as global positioning system (GPS) or Glonass signals.

In an exemplary embodiment, the first or primary cellular antenna is a monopole antenna (e.g., stamped metal wide band monopole antenna mast, etc.). The monopole antenna is configured to be operable for both receiving and transmitting communication signals within one or more cellular frequency bands. Continuing with this example, the second or secondary cellular antenna is an inverted F antenna (IFA) that is configured to be operable for receiving (but not transmitting) communication signals within one or more cellular frequency bands. The first and second cellular antennas are positioned relatively close to each other, but the antenna assembly is configured such that sufficient de-correlation (e.g., a correlation less than about 25 percent, etc.) and sufficiently low coupling exists despite the close spacing of the cellular antennas. By way of example, the antenna assembly may be configured such there is at least about 15 decibels of isolation between the cellular antennas.

This example antenna assembly also includes first and second patch antennas. The first patch antenna may be configured to be operable for receiving SDARS signals (e.g., Sirius XM, etc.). The second patch antenna may be configured to be operable for receiving GPS signals and/or Glonass signals, etc.

The inventors hereof have found that their combination of a second cellular antenna (e.g., inverted L antenna (ILA), inverted F antenna (IFA), planar inverted F antenna (PIFA), etc.) with a first wide band monopole cellular antenna (e.g., stamped metal wide band monopole antenna mast, etc.) provides low correlation, high efficiency, and a compact assembly suitable for use with automotive antenna systems. In some exemplary embodiments, the multiple antennas are configured (e.g., sized, shaped, closely spaced, isolated, etc.) such that the antenna assembly may be disposed within or under some existing radomes or covers. This, in turn, allows the inventors' antenna assemblies to be usable with some existing antenna radomes despite the addition of the second (receiving) cellular antenna as the overall size has not been considerably increased.

Accordingly, exemplary embodiments are disclosed herein of antenna assemblies having two cellular antennas operable within various cellular frequency bands (e.g., LTE frequencies, etc.) and one or more antennas providing GPS and satellite functionality. Such exemplary embodiments are configured so that there is sufficient isolation, sufficiently low coupling, and sufficiently low correlation between the cellular antennas to allow the cellular antenna to be positioned relatively close to each other (e.g., colocated on a common chassis and/or under the same radome, etc.). The low correlation/coupling allows the number of cellular antennas to be increased without considerably increasing the size of the antenna assembly and without appreciably degrading or affecting the performance of the satellite antennas (e.g., GPS and/or Sirius XM, etc.).

By way of example, either or both of the first and second cellular antennas herein may be configured to be operable within one or more frequency bandwidths associated with cellular communications, such as one or more (or all) of AMPS/GSM850, GSM900, GSM1800, PCS/GSM1900, UMTS/AWS, GSM850, GSM1900, AWS, LTE (e.g., 4G, 3G, other LTE generation, B17 (LTE), LTE (700 MHz), etc.), AMPS, PCS, EBS (Educational Broadband Services), BRS (Broadband Radio Services), WCS (Broadband Wireless Communication Services/Internet Services), cellular frequency bandwidth(s) associated with or unique to a particular one or more geographic regions or countries, one or more frequency bandwidth(s) from Table 1 and/or Table 2 below, etc. In some exemplary embodiments, the first and second cellular antennas may be configured such that the antenna assembly is operable practically anywhere in the world due to the numerous and varied frequencies over which the antenna assembly is operable.

TABLE 1

| | Upper Frequency | Lower Frequency |
|---|---|---|
| System/Band Description | (MHz) | (MHz) |
| 700 MHz Band | 698 | 862 |
| B17 (LTE) | 704 | 787 |
| AMPS/GSM850 | 824 | 894 |
| GSM 900 (E-GSM) | 880 | 960 |
| DCS 1800/GSM1800 | 1710 | 1880 |
| PCS/GSM1900 | 1850 | 1990 |
| W CD MA/UMTS | 1920 | 2170 |
| 2.3 GHz Band IMT Extension | 2300 | 2400 |
| IEEE 802.11B/G | 2400 | 2500 |
| EBS/BRS | 2496 | 2690 |
| W IMAX MMDS | 2500 | 2690 |
| BROADBAND RADIO | 2700 | 2900 |
| SERVICES/BRS (MMDS) | | |
| W IMAX (3.5 GHz) | 3400 | 3600 |
| PUBLIC SAFETY RADIO | 4940 | 4990 |

TABLE 2

| | Tx/Uplink (MHz) | | Rx/Downlink (MHz) | |
|---|---|---|---|---|
| Band | Start | Stop | Start | Stop |
| GSM 850/AMPS | 824.00 | 849.00 | 869.00 | 894.00 |
| GSM 900 | 876.00 | 914.80 | 915.40 | 959.80 |
| AWS | 1710.00 | 1755.80 | 2120.00 | 2180.00 |
| GSM 1800 | 1710.20 | 1784.80 | 1805.20 | 1879.80 |
| GSM 1900 | 1850.00 | 1910.00 | 1930.00 | 1990.00 |
| UMTS | 1920.00 | 1980.00 | 2110.00 | 2170.00 |
| LTE | 2010.00 | 2025.00 | 2010.00 | 2025.00 |
| LTE | 2300.00 | 2400.00 | 2300.00 | 2400.00 |
| LTE | 2496.00 | 2690.00 | 2496.00 | 2690.00 |
| LTE | 2545.00 | 2575.00 | 2545.00 | 2575.00 |
| LTE | 2570.00 | 2620.00 | 2570.00 | 2620.00 |

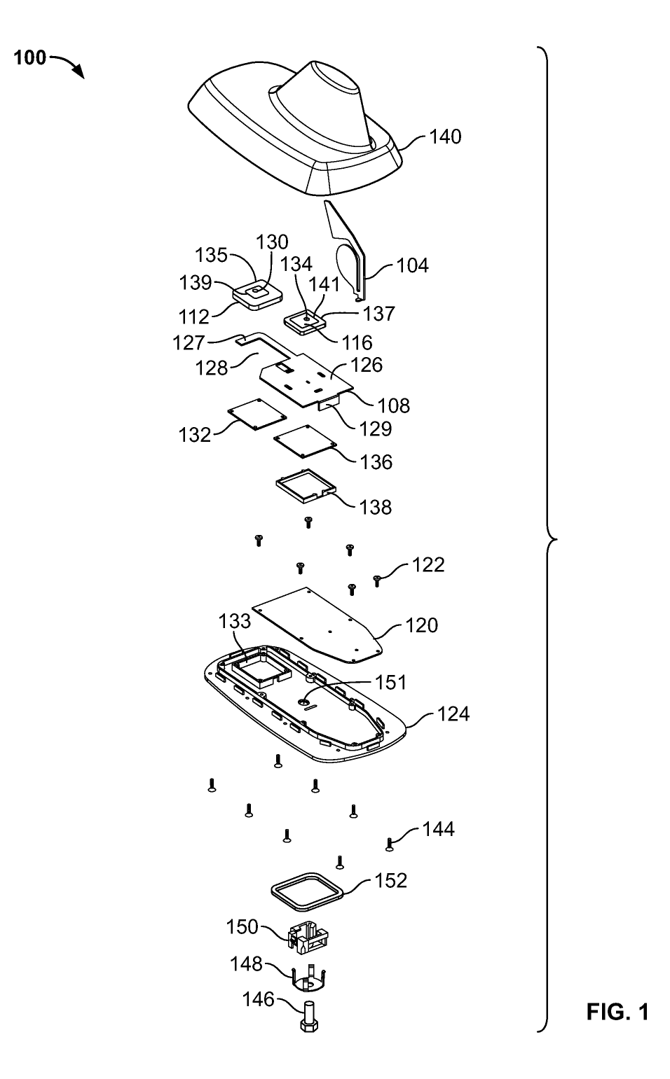

With reference now to the figures, FIGS. 1 through 3 illustrate an antenna assembly 100 embodying one or more aspects of the present disclosure. As shown in FIG. 1, the antenna assembly 100 includes a first or primary cellular antenna 104 and a second or secondary cellular antenna 108. The antenna assembly 100 also includes a first patch satellite antenna 112 and a second patch satellite antenna 116.

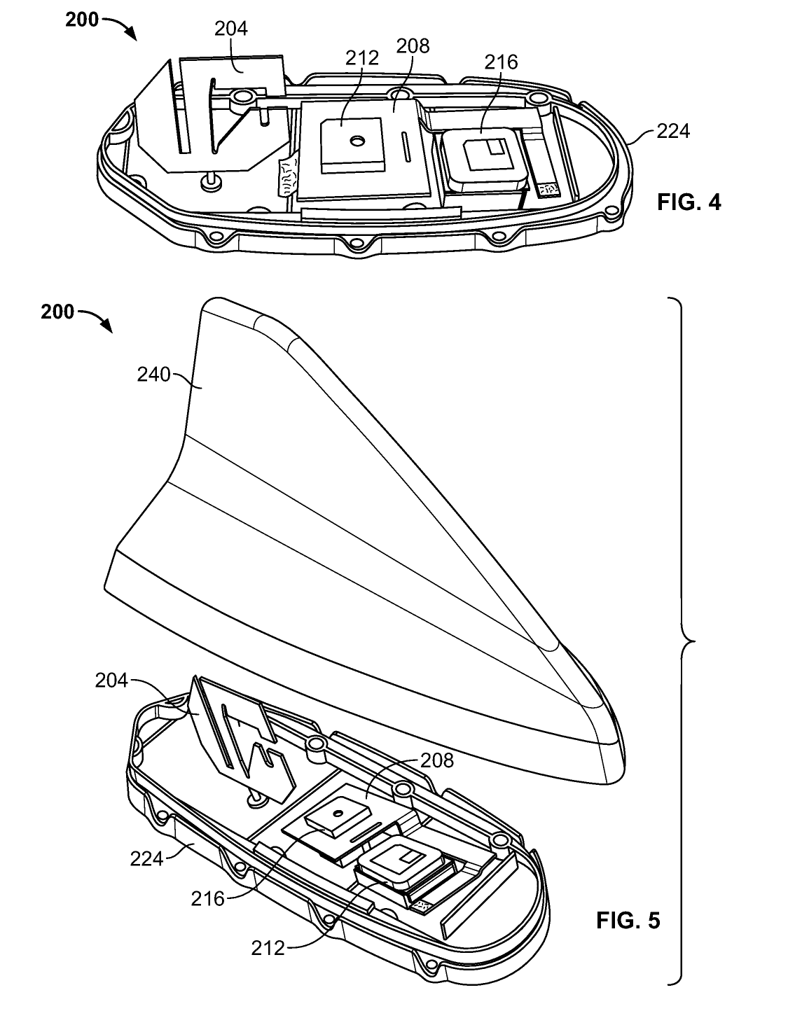

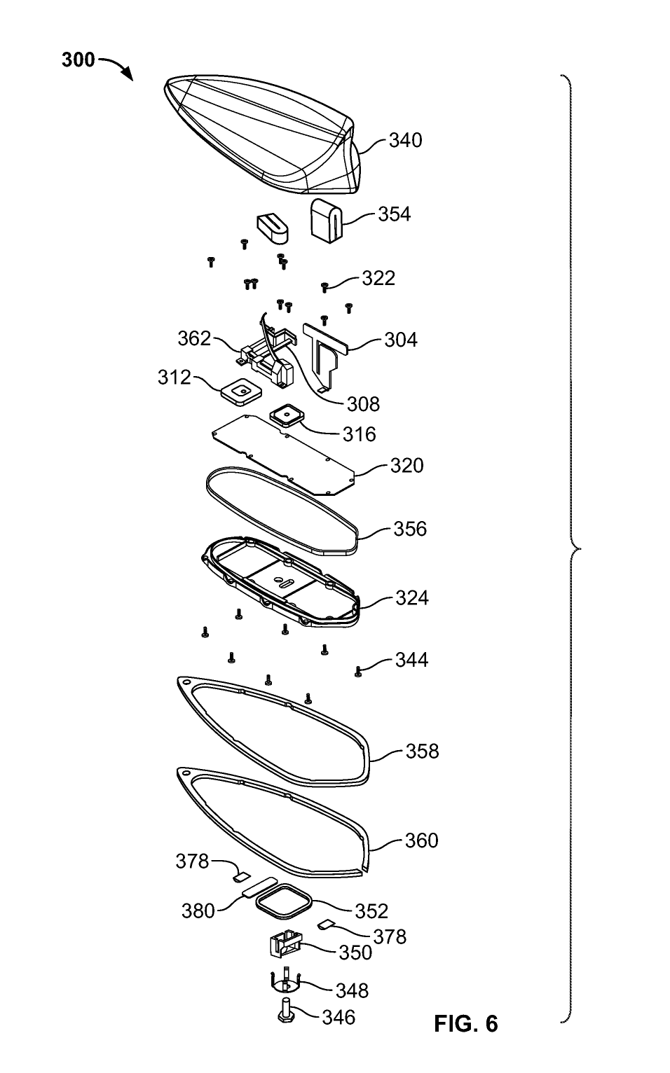

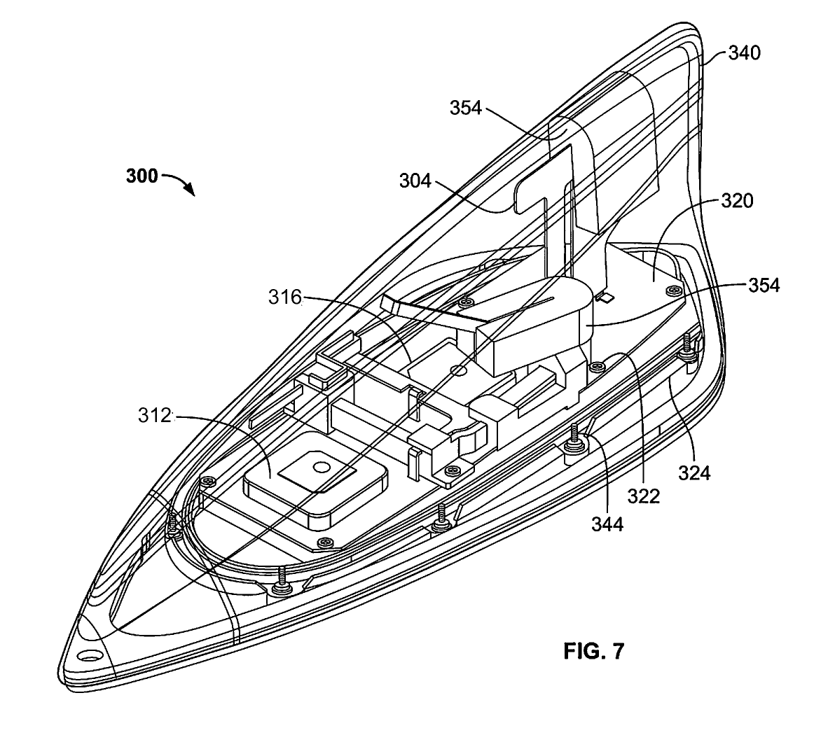

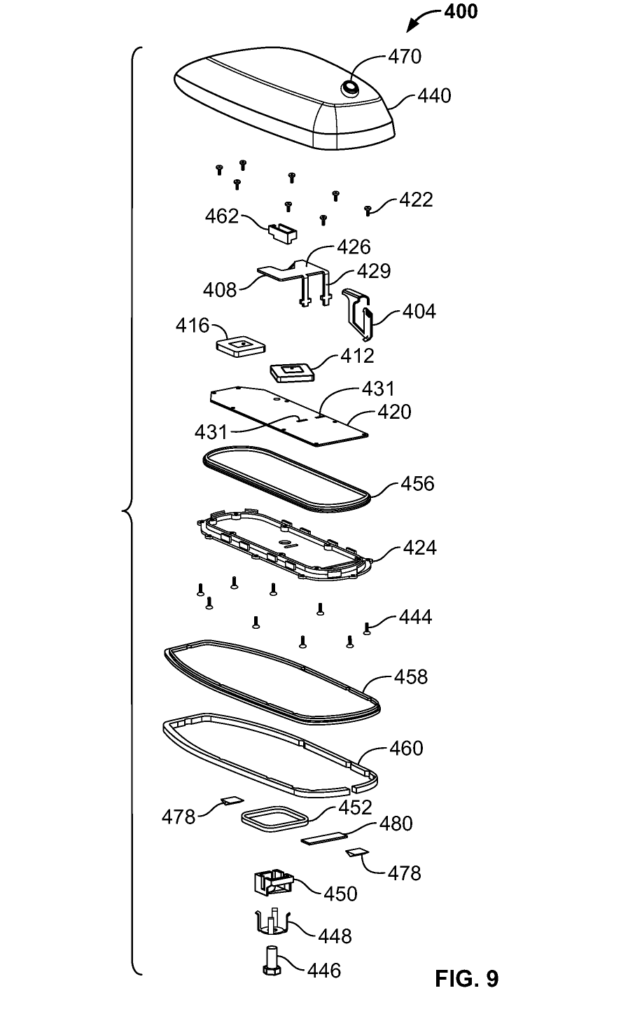

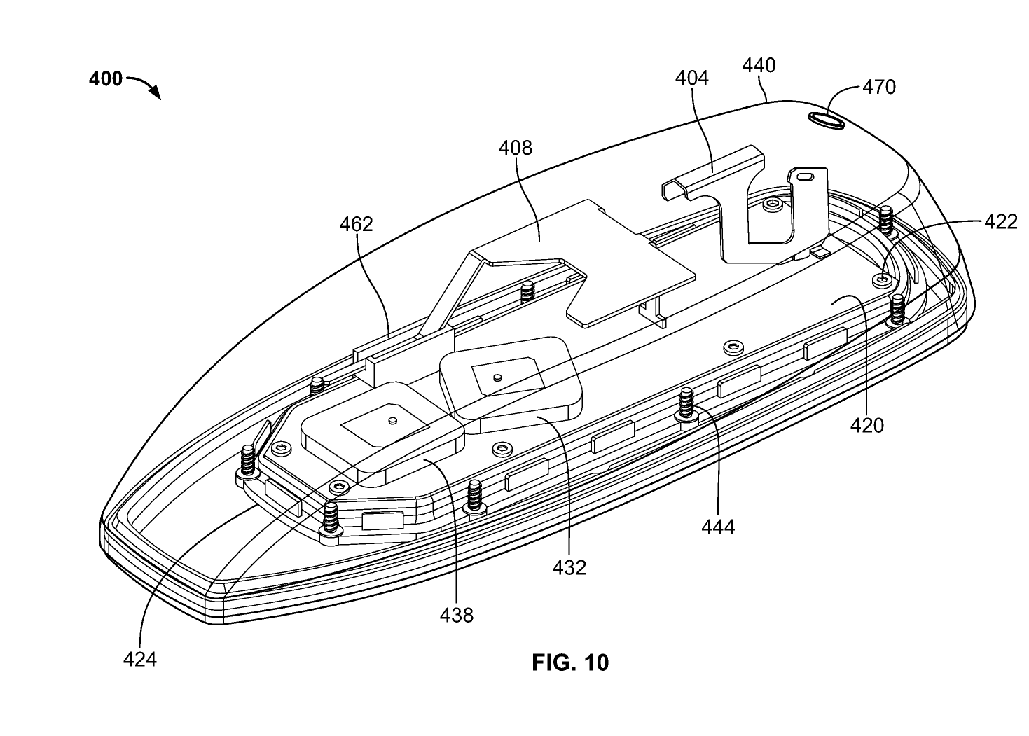

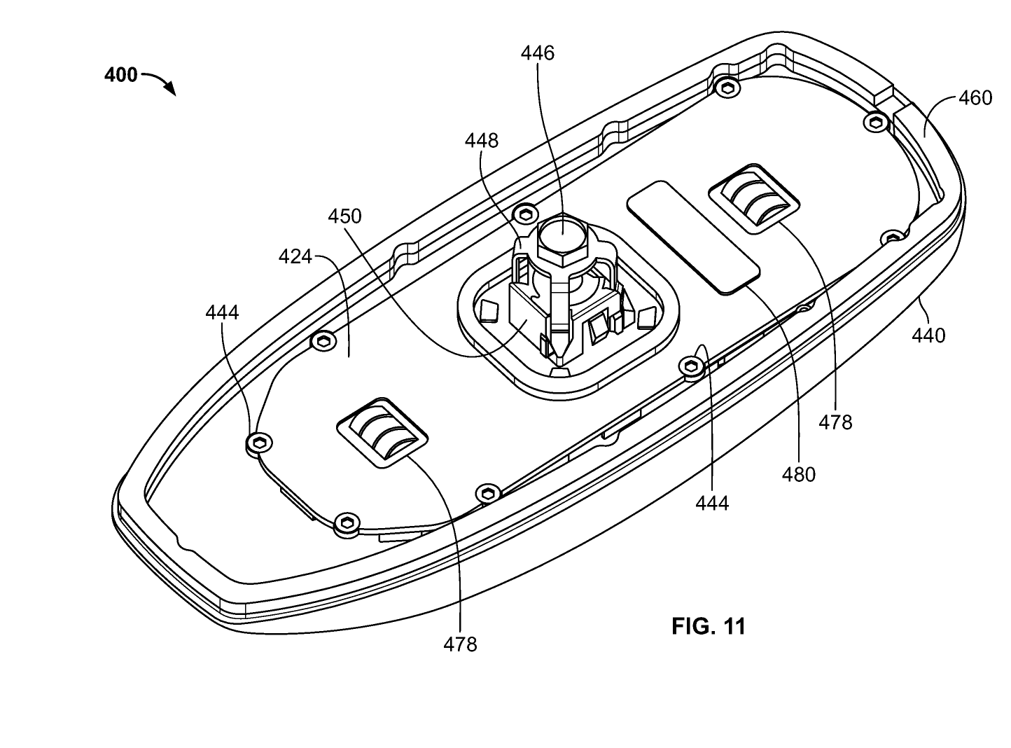

In this illustrated embodiment, the first cellular antenna 104 is a monopole antenna (e.g., stamped metal wide band monopole antenna mast, etc.) configured to be operable for both receiving and transmitting communication signals within one or more cellular frequency bands (e.g., LTE, etc.). By way of example only, the first cellular antenna 104 may be a cellular antenna mast that is identical to or substantially identical to an antenna mast (e.g., stamped metal monopole antenna mast, etc.) disclosed in U.S. Pat. No. 7,492,318, the entire contents of which is incorporated herein by reference. Alternative embodiments may include a first cellular antenna that is configured differently (e.g., cellular antenna 204 (FIGS. 4 and 5), cellular antenna 304 (FIGS. 6 and 7), cellular antenna 404 (FIGS. 9 and 10), etc.) than shown in FIG. 1 of this application or disclosed in U.S. Pat. No. 7,492,318.

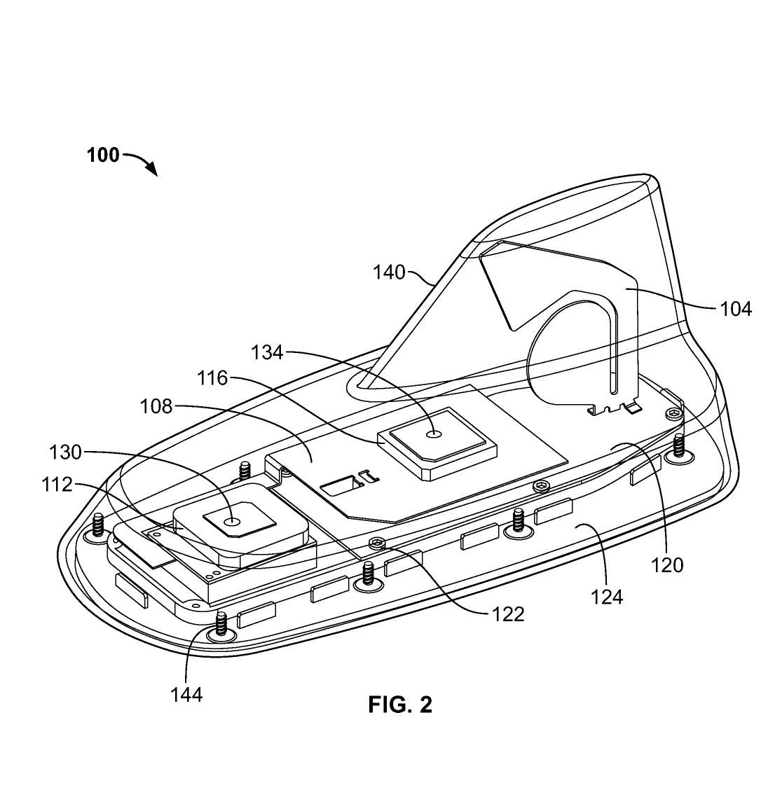

As shown in FIG. 2, the first cellular antenna 104 is connected to and supported by a printed circuit board (PCB) 120. For example, the first cellular antenna 104 has one or more bent or formed tabs at the bottom, which may provide areas for soldering the first cellular antenna 104 to the PCB 120. The first cellular antenna 104 may also include a downwardly extending projection that may be at least partially received within a corresponding opening in the PCB 120, for example, to make electrical connection to a PCB component on the opposite side of the PCB 120. Alternatively, other embodiments may include other means for soldering or connecting the first cellular antenna 104 to the PCB 120.

The PCB 120 is supported by a chassis or body 124. In this example embodiment, the PCB 120 is mechanically fastened via fasteners 122 (e.g., screws, etc.) to the chassis 124.

Continuing with this illustrated embodiment of FIG. 1, the second cellular antenna 108 is an inverted F antenna (IFA) configured to be operable for receiving (but not transmitting) communication signals within one or more cellular frequency bands (e.g., LTE, etc.). The second cellular antenna 108 may comprise stamped and bent sheet metal. Alternative embodiments may include a second cellular antenna that is configured differently (e.g., inverted L antenna (ILA), planar inverted F antenna (PIFA), an antenna made of different materials and/or via different manufacturing processes, etc.).

As shown in FIG. 2, the second cellular antenna 108 is also connected to and supported by the printed circuit board (PCB) 120 by, for example, soldering, etc. In addition, the second cellular antenna 108 includes a planar surface 126 on which is disposed or mounted the second patch antenna 116. The second cellular antenna 108 also includes a generally L-shaped extension 127 that defines an opening or recess 128 configured (e.g., sized, shaped, located, etc.) to allow the first patch antenna 112 to be positioned at least partially therethrough. The second cellular antenna 108 also includes a downwardly extending portion, leg, or short 129 (FIG. 1) generally perpendicular to the planar surface 126, which may be operable for electrically connecting the second cellular antenna 108 to a ground plane.

The first patch antenna 112 may be positioned at least partially through the opening 128 to allow a connector 130 (e.g., feed pin, interlayer connector, etc.) that extends through the first patch antenna 112 to be connected (e.g., soldered, etc.) to a printed circuit board (PCB) 132. By way of example, the first patch antenna connector 130 may be connected to a low noise amplifier of the PCB 132. The PCB 132 may be positioned at least partially within a cavity or recess 133 defined by the chassis 124.

With further regard for the first and second patch antennas 112 and 116, they may be configured to be operable for receiving satellite signals. In this illustrated embodiment, the first patch antenna 112 is configured to be operable for receiving SDARS signals (e.g., Sirius XM, etc.). The second patch antenna 116 is configured to be operable for receiving GPS signals. In another embodiment, the first and second patch antennas 112, 116 may be in a stacked arrangement with one of the patch antennas stacked on the other one.

As noted above, the first patch antenna 112 includes the connector 130 extending therethrough which may be soldered, etc. to the PCB 132. The second patch antenna 116 also includes a connector 134 (e.g., feed pin, interlayer connector, etc.) that extends through the second patch antenna 116. As shown in FIG. 1, the planar surface 126 of second cellular antenna 108 includes a through hole to allow the connector 134 to pass therethrough, such that the second patch antenna connector 134 may be connected (e.g., soldered, etc.) to a printed circuit board (PCB) 136 via the connector 134. By way of example, the second patch antenna connector 134 may be connected to a low noise amplifier of the PCB 136.

Each patch antenna 112, 116 may include a substrate 135, 137, respectively, made of a dielectric material, for example, a ceramic. An electrically conductive material may be disposed on the upper surface of the substrate to form the antenna structure 139, 141 (e.g., λ/2-antenna structure, etc.) of the respective patch antennas 112, 116. The connectors 130, 134 may connect the antenna structure 139, 141 of the respective patch antennas 112, 116, respectively, to the corresponding PCB 132, 136. A metallization may cover the entire area (or substantially the entire area) of the lower surface of the substrate of each patch antenna 112, 116. For example, a metallization may be provided on the lower surface of the substrate. Additionally, or alternatively, a metallization may be a separate or discrete metallization element abutting against the lower surface of the substrate. Each connector 130, 134 runs through the corresponding substrate 135, 137 to preferably provide a galvanic connection between the antenna structure 139, 141 on the top of the substrate and the metallization on the bottom of the substrates, setting these at equal potential. The connectors 130, 134 may be provided preferably at the middle of the antenna structures on the substrates, where no significant voltage, yet maximum current of the induced current, appears.

With continued reference to FIG. 1, the antenna assembly 100 also includes a shield 138 (e.g., board level one-piece metal shielding can, etc.). In operation, the shield 138 provides electromagnetic interference (EMI) shielding to an amplifier (e.g., low noise amplifier, etc.) or amplification chamber between the PCB 120 and PCB 136.

The antenna assembly 100 includes a radome or cover 140 provided to help protect the various components of the antenna assembly 100 enclosed within an interior spaced defined by the cover 140 and the chassis 124. For example, the cover 140 can substantially seal the components of the antenna assembly 100 within the cover 140 thereby protecting the components against ingress of contaminants (e.g., dust, moisture, etc.) into an interior enclosure of the cover 140. In addition, the cover 140 can provide an aesthetically pleasing appearance to the antenna assembly 100, and can be configured (e.g., sized, shaped, constructed, etc.) with an aerodynamic configuration. In FIG. 2, the radome or cover 140 is shown transparent for clarity to allow the components thereunder to be visible. The radome or cover 140 (and any other radome or cover disclosed herein) may be opaque, translucent, transparent, and/or be provided in a variety of colors. In other example embodiments, antenna assemblies may include covers having configurations different than illustrated herein. The cover 140 (and any other cover disclosed herein) may be formed from a wide range of materials, such as, for example, polymers, urethanes, plastic materials (e.g., polycarbonate blends, Polycarbonate-Acrylnitril-Butadien-Styrol-Copolymer (PC/ABS) blend, etc.), glass-reinforced plastic materials, synthetic resin materials, thermoplastic materials (e.g., GE Plastics Geloy® XP4034 Resin, etc.), etc. within the scope of the present disclosure.

The cover 140 is configured to fit over the first and second cellular antennas 104, 108 and first and second patch antennas 112, 116 such that the antennas 104, 108, 112, 116 are colocated under the cover 140. The cover 140 is configured to be secured to the chassis 124. In this illustrated embodiment, the cover 140 is secured to the chassis 124 by mechanical fasteners 144 (e.g., screws, etc.). Alternatively, the cover 140 may secure to the chassis 124 via any suitable operation, for example, a snap fit connection, mechanical fasteners (e.g., screws, other fastening devices, etc.), ultrasonic welding, solvent welding, heat staking, latching, bayonet connections, hook connections, integrated fastening features, etc.

The chassis or base 124 may be configured to couple to a roof of a car for installing the antenna assembly 100 to the car. Alternatively, the cover 140 may connect directly to the roof of a car within the scope of the present disclosure.

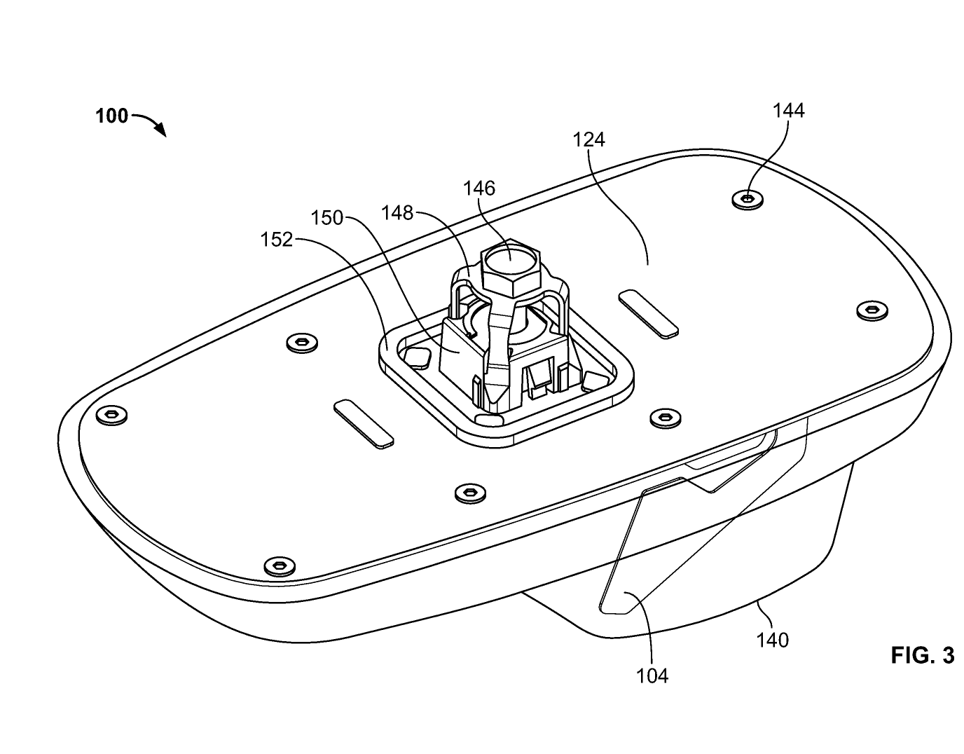

As shown in FIGS. 1 and 3, the antenna assembly 100 includes a fastener member 146 (e.g., threaded mounting bolt having a hexagonal head, etc.), a first retention component 148 (e.g., an insulator clip, etc.), and a second retention component 150 (e.g., retaining clip, etc.). The fastener member 146 and retention members 148, 150 may be used to mount the antenna assembly to an automobile roof, hood, trunk (e.g., with an unobstructed view overhead or toward the zenith, etc.) where the mounting surface of the automobile acts as a ground plane for the antenna assembly.

The fastener member 146 and retaining components 148, 150 allow the antenna assembly 100 to be installed and fixedly mounted to a vehicle body wall. The fastener member 146 and retaining components 148, 150 may first be inserted into a mounting hole in the vehicle body wall from an external side of the vehicle such that the chassis 124 is disposed on the external side of the vehicle body wall and the fastener 146 is accessible from inside the vehicle. In this stage of the installation process, the antenna assembly 100 may thus be held in place relative to the vehicle body wall in a first installed position.

The first retaining component 148 includes legs, and the second retaining component 150 includes tapered faces. The first and second retaining components 148, 150 also include aligned openings through which passes the fastener member 146 to be threadedly connected to a threaded opening 151 in the chassis 124.

The legs of the first retaining component 148 are configured to make contact with the corresponding tapered faces of the second retaining component 150. When the first retaining component 148 is compressively moved generally towards the mounting hole by driving the fastener member 146 in a direction generally towards the antenna base 124, the legs may deform and expand generally outwardly relative to the mounting hole against the interior compartment side of the vehicle body wall, thereby securing the antenna assembly 100 to the vehicle body wall in a second, operational installed position.

In other embodiments, an antenna assembly may include a fastener member, first retaining component, and second retaining component as disclosed in U.S. Pat. No. 7,492,319, the entire contents of which is incorporated herein by reference. The antenna assembly could be mounted differently within the scope of the present disclosure. For example, the antenna assembly could be installed to a truck, a bus, a recreational vehicle, a boat, a vehicle without a motor, etc. within the scope of the present disclosure.

The chassis 124 (and any other chassis disclosed herein) may be formed from a wide range of materials. For example, the chassis 124 may be injection molded from polymer. Alternatively, the chassis 124 may be formed from steel, zinc, or other material (including composites) by a suitable forming process, for example, a die cast process, etc. within the scope of the present disclosure. As a further example, the antenna assembly 100 may include a composite antenna chassis or base that is identical to or substantially identical to a composite chassis or base disclosed in U.S. Patent Application Publication 2008/0100521, the entire contents of which is incorporated herein by reference.

As shown in FIGS. 1 and 3, the antenna assembly 100 includes a sealing member 152 (e.g., an O-ring, a resiliently compressible elastomeric or foam gasket, a PORON microcellular urethane foam gasket, etc.) that will be positioned between the chassis 124 and the roof of a car (or other mounting surface). The sealing member 152 may substantially seal the chassis 124 against the roof and substantially seal the mounting hole in the roof. One or more sealing members (e.g., an O-ring, a resiliently compressible elastomeric or foam gasket, caulk, adhesives, other suitable packing or sealing members, etc.) may also, or alternatively, be provided between the radome 140 and the chassis 124 for substantially sealing the radome 140 against the chassis 124. A sealing member may be at least partially seated within a groove defined along or by the chassis 124. In some embodiments, sealing may be achieved by one or more integral sealing features rather than with a separate sealing mechanism.

In this illustrated embodiment of FIGS. 1 through 3, the first and second cellular antennas 104, 108 are positioned relatively close to each other. The antenna assembly 100 is preferably configured such there is sufficient de-correlation (e.g., a correlation less than about 25 percent, etc.), sufficiently low coupling, and sufficient isolation (e.g., at least about 15 decibels, etc.) between the cellular antennas 104, 108. The multiband MIMO antenna assembly 100 is operable over multiple frequency bands, including LTE and others.

Also, in this example embodiment, the antenna assembly 100 may be configured to have a height of about 66 millimeters and a footprint having a length of about 162 millimeters and a width of about 83 millimeters. These dimensions, as are all dimensions disclosed herein, are not intended to limit the scope of the present disclosure, as other embodiments may be dimensionally sized larger or smaller depending, for example, on the particular application and intended end use.

FIGS. 4 and 5 show a second exemplary embodiment of an antenna assembly 200 embodying one or more aspects of the present disclosure. As shown in FIGS. 4 and 5, the antenna assembly 200 includes a first or primary cellular antenna 204 and a second or secondary cellular antenna 208. The antenna assembly 200 also includes a first patch antenna 212 and a second patch antenna 216.

In this illustrated second embodiment, the first cellular antenna 204 is a monopole antenna (e.g., stamped metal wide band monopole antenna mast, etc.) configured to be operable for both receiving and transmitting communication signals within one or more cellular frequency bands (e.g., LTE, etc.). Alternative embodiments may include a first cellular antenna that is configured differently (e.g., cellular antenna 104 shown in FIG. 1, etc.) than shown in FIGS. 4 and 5.

The second cellular antenna 208 is an inverted F antenna (IFA) configured to be operable for receiving (but not transmitting) communication signals within one or more cellular frequency bands (e.g., LTE, etc.). Alternative embodiments may include a second cellular antenna that is configured differently (e.g., inverted L antenna (ILA), planar inverted F antenna (PIFA), etc.).

With further regard for the first and second patch antennas 212 and 216, they may be configured to be operable for receiving satellite signals. In this illustrated embodiment, the first patch antenna 212 is configured to be operable for receiving SDARS signals (e.g., Sirius XM, etc.). The second patch antenna 216 is configured to be operable for receiving GPS signals.

As shown in FIG. 5, the antenna assembly 200 includes a radome or cover 240. The cover 240 can provide an aesthetically pleasing appearance to the antenna assembly 200, and can be configured (e.g., sized, shaped, constructed, etc.) with an aerodynamic configuration. In the illustrated embodiment, for example, the cover 240 has an aesthetically pleasing, aerodynamic shark-fin configuration. In other example embodiments, antenna assemblies may include covers having configurations different than illustrated herein, for example, having configurations other than shark-fin configurations, etc. The cover 240 may be formed from a wide range of materials, such as, for example, polymers, urethanes, plastic materials (e.g., polycarbonate blends, Polycarbonate-Acrylnitril-Butadien-Styrol-Copolymer (PC/ABS) blend, etc.), glass-reinforced plastic materials, synthetic resin materials, thermoplastic materials (e.g., GE Plastics Geloy® XP4034 Resin, etc.), etc. within the scope of the present disclosure.

The antenna assembly 200 may further include other components and features similar or identical in structure and/or operation as the corresponding features of the antenna assembly 100 shown in FIGS. 1 through 3. For example, the antenna assembly 200 may also include a chassis 224, shield 138, fastener member 146, first retaining component 148, second retaining component 150, and/or sealing member 152. Alternatively, the antenna assembly 200 may include components (e.g., first cellular antenna 204, radome 240, etc.) configured differently that the corresponding components of the antenna assembly 100.

In this exemplary embodiment shown in FIGS. 4 and 5, the first and second cellular antennas 204, 208 are positioned relatively close to each other. The antenna assembly 200 is preferably configured such there is sufficient de-correlation (e.g., a correlation less than about 25 percent, etc.), sufficiently low coupling, and sufficient isolation (e.g., at least about 15 decibels, etc.) between the cellular antennas 204, 208. The multiband MIMO antenna assembly 200 is operable over multiple frequency bands, including LTE and others.

FIGS. 6 through 8 show a third exemplary embodiment of an antenna assembly 300 embodying one or more aspects of the present disclosure. As shown in FIGS. 6 and 7, the antenna assembly 300 includes a first or primary cellular antenna 304 and a second or secondary cellular antenna 308. The antenna assembly 300 also includes a first patch antenna 312 and a second patch antenna 316.

In this illustrated third embodiment, the first cellular antenna 304 is a monopole antenna (e.g., stamped metal wide band monopole antenna mast, etc.) configured to be operable for both receiving and transmitting communication signals within one or more cellular frequency bands (e.g., LTE, etc.). Alternative embodiments may include a first cellular antenna that is configured differently (e.g., cellular antenna 104 shown in FIG. 1, cellular antenna 204 shown in FIG. 4, etc.) than shown in FIGS. 6 and 7.

The second cellular antenna 308 is configured to be operable for receiving (but not transmitting) communication signals within one or more cellular frequency bands (e.g., LTE, etc.).The second cellular antenna 308 is supported and held in position by an overmold 362, which may comprise a piece of plastic or other dielectric material overmolded onto the second cellular antenna 308. Alternative embodiments may include a second cellular antenna that is configured differently (e.g., inverted L antenna (ILA), planar inverted F antenna (PIFA), etc.).

With further regard for the first and second patch antennas 312 and 316, they may be configured to be operable for receiving satellite signals. In this illustrated embodiment, the first patch antenna 312 is configured to be operable for receiving SDARS signals (e.g., Sirius XM, etc.). The second patch antenna 316 is configured to be operable for receiving GPS signals.

The first and second cellular antennas 304, 308 are connected to and supported by a printed circuit board (PCB) 320 by, for example, soldering, etc. As shown in FIG. 7, the first cellular antenna 304 has one or more bent or formed tabs at the bottom, which may provide areas for soldering the first cellular antenna 304 to the PCB 320. The first cellular antenna 304 may also include a downwardly extending projection that may be at least partially received within a corresponding opening in the PCB 320, for example, to make electrical connection to a PCB component on the opposite side of the PCB 320. Alternatively, other embodiments may include other means for soldering or connecting the first cellular antenna 304 to the PCB 320.

The PCB 320 is supported by a chassis or body 324. In this example embodiment, the PCB 320 is mechanically fastened via fasteners 322 (e.g., screws, etc.) to the chassis 324.

The antenna assembly 300 further includes foam pads 354. As shown in FIG. 7, the foam pads 354 may be positioned about portions of the first and second cellular antennas 304, 308, for example, to help hold the antennas in place and/or inhibit vibrations during travel of the vehicle to which the antenna assembly 300 in mounted.

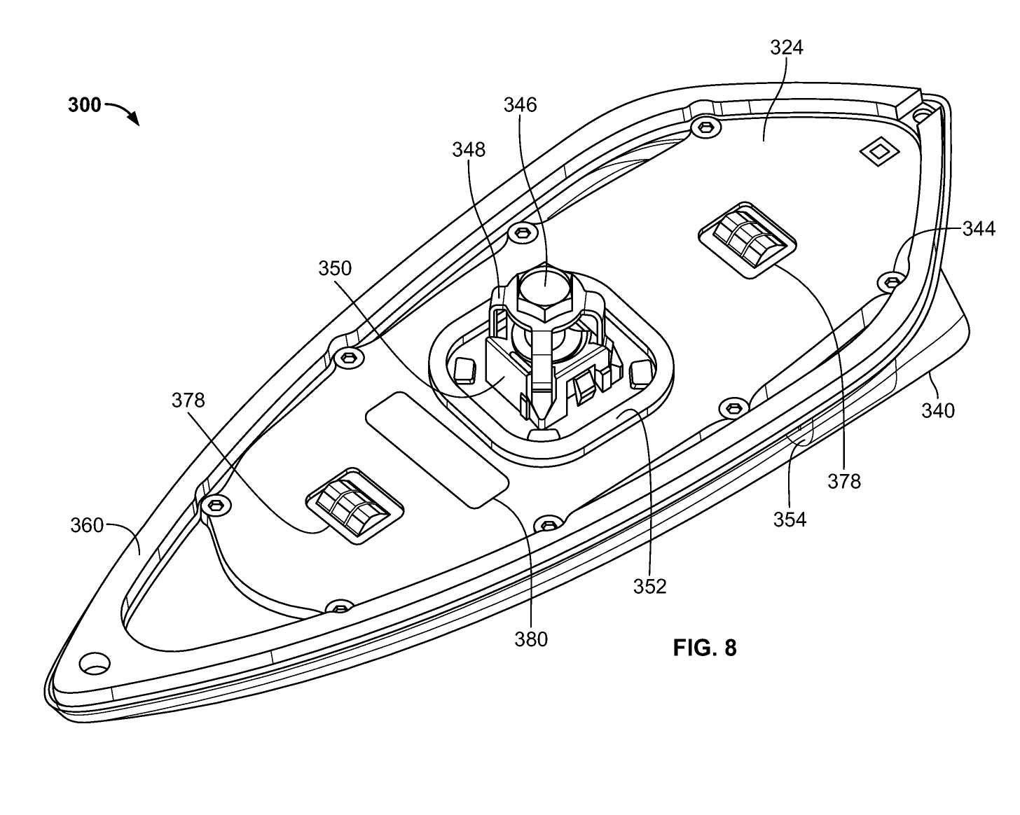

As shown in FIGS. 6 and 8, the antenna assembly 300 includes gaskets 378 and 380. In operation, the gaskets 378 and 380 help ensure that the chassis 324 will be grounded to a vehicle roof and also allows the antenna assembly 300 to be used with different roof curvatures. As shown in FIG. 8, the gaskets 378 include electrically-conductive fingers (e.g., metallic or metal spring fingers, etc.). In an exemplary embodiment, the gaskets comprise fingerstock gaskets from Laird Technologies, Inc.

The antenna assembly 300 may further include other components and features similar or identical in structure and/or operation as the corresponding features of the antenna assembly 100 shown in FIGS. 1 through 3. For example, the antenna assembly 300 includes a chassis 324 and a radome or cover 340. In the illustrated embodiment, for example, the cover 340 has an aesthetically pleasing, aerodynamic shark-fin configuration. The cover 340 is configured to fit over the first and second cellular antennas 304, 308 and first and second patch antennas 312, 316 such that the antennas 304, 308, 312, 316 are colocated under the cover 340.

The cover 340 is configured to be secured to the chassis 324. In this illustrated embodiment, the cover 340 is secured to the chassis 324 by mechanical fasteners 344 (e.g., screws, etc.). Alternatively, the cover 340 may secure to the chassis 324 via any suitable operation, for example, a snap fit connection, mechanical fasteners (e.g., screws, other fastening devices, etc.), ultrasonic welding, solvent welding, heat staking, latching, bayonet connections, hook connections, integrated fastening features, etc.

The chassis or base 324 may be configured to couple to a roof of a car for installing the antenna assembly 300 to the car. Alternatively, the cover 340 may connect directly to the roof of a car within the scope of the present disclosure.

As shown in FIGS. 6 and 8, the antenna assembly 300 includes a fastener member 346 (e.g., threaded mounting bolt having a hexagonal head, etc.), a first retention component 348 (e.g., an insulator clip, etc.), and a second retention component 350 (e.g., retaining clip, etc.). In a similar manner as that explained above for antenna assembly 100, the fastener member 346 and retention members 348, 350 may be used to mount the antenna assembly 300 to an automobile roof, hood, trunk (e.g., with an unobstructed view overhead or toward the zenith, etc.).

Also shown in FIGS. 6 and 8, the antenna assembly 300 includes a sealing member 352 (e.g., an O-ring, a resiliently compressible elastomeric or foam gasket, a PORON microcellular urethane foam gasket, etc.) that will be positioned between the chassis 324 and the roof of a car (or other mounting surface). The sealing member 352 may substantial seal the chassis 324 against the roof and substantially seal the mounting hole in the roof. The antenna assembly 300 also includes a sealing member 356 (e.g., an O-ring, a resiliently compressible elastomeric or foam gasket, caulk, adhesives, other suitable packing or sealing members, etc.) that is positioned between the radome 340 and the chassis 324 for substantially sealing the radome 340 against the chassis 324. In this example, the sealing member 356 may be at least partially seated within a groove defined along or by the chassis 324. Also in this example, there are sealing members 358, 360 that are positioned between the radome 340 and the roof of the car (or other mounting surface) with the sealing member 358 on top of the sealing member 360. In operation, the sealing members 358, 360 may be operable as seals against dust, etc. and as a shield support. In some embodiments, sealing may be achieved by one or more integral sealing features rather than with a separate sealing mechanism.

The first and second cellular antennas 304, 308 are positioned relatively close to each other. The antenna assembly 300 is preferably configured such there is sufficient de-correlation (e.g., a correlation less than about 25 percent, etc.), sufficiently low coupling, and sufficient isolation (e.g., at least about 15 decibels, etc.) between the cellular antennas 304, 308. The multiband MIMO antenna assembly 300 is operable over multiple frequency bands, including LTE and others.

FIGS. 9 through 11 show a fourth exemplary embodiment of an antenna assembly 400 embodying one or more aspects of the present disclosure. As shown in FIGS. 9 and 10, the antenna assembly 400 includes a first or primary cellular antenna 404 and a second or secondary cellular antenna 408. The antenna assembly 400 also includes a first patch antenna 412 and a second patch antenna 416.

In this example, the first cellular antenna 404 is configured to be operable for both receiving and transmitting communication signals within one or more cellular frequency bands (e.g., LTE, etc.). In addition, the first cellular antenna 404 may also be configured to be operable with the amplitude modulation (AM) band and the frequency modulation (FM) band and/or to be connected with an antenna mast that is received partially through an opening 470 in the radome 440. Accordingly, the first cellular antenna 404 may also be referred to herein as an AM/FM cellular antenna. Alternative embodiments may include a first cellular antenna that is configured differently (e.g., cellular antenna 104 shown in FIG. 1, cellular antenna 204 shown in FIG. 4, cellular antenna 304 shown in FIG. 6, etc.) than shown in FIGS. 9 and 10.

The second cellular antenna 408 is configured to be operable for receiving (but not transmitting) communication signals within one or more cellular frequency bands (e.g., LTE, etc.).The second cellular antenna 408 is supported and held in position by a support 462, which may comprise plastic or other dielectric material. The second cellular antenna 408 includes downwardly extending portions, legs, or shorts 429 (FIG. 9) generally perpendicular to a planar surface 426 of the second cellular antenna 408. The legs 429 are configured to be slotted or extend into holes 431 in a printed circuit board (PCB) 420 for connection (e.g., solder, etc.) to a feed network. Alternative embodiments may include a second cellular antenna that is configured differently (e.g., inverted L antenna (ILA), planar inverted F antenna (PIFA), etc.).

With further regard for the first and second patch antennas 412 and 416, they may be configured to be operable for receiving satellite signals. In this illustrated embodiment, the first patch antenna 412 is configured to be operable for receiving SDARS signals (e.g., Sirius XM, etc.). The second patch antenna 416 is configured to be operable for receiving GPS signals.

The first and second cellular antennas 404, 408 are connected to and supported by the PCB 420 by, for example, soldering, etc. As shown in FIGS. 9 and 10, the first cellular antenna 404 has one or more bent or formed tabs at the bottom, which may provide areas for soldering the first cellular antenna 404 to the PCB 420. The first cellular antenna 404 may also include a downwardly extending projection that may be at least partially received within a corresponding opening in the PCB 420, for example, to make electrical connection to a PCB component on the opposite side of the PCB 420. Alternatively, other embodiments may include other means for soldering or connecting the first cellular antenna 404 to the PCB 420.

The PCB 420 is supported by a chassis or body 424. In this example embodiment, the PCB 420 is mechanically fastened via fasteners 422 (e.g., screws, etc.) to the chassis 424.

As shown in FIGS. 9 and 11, the antenna assembly 400 includes gaskets 478 and 480. In operation, the gaskets 478 and 480 help ensure that the chassis 424 will be grounded to a vehicle roof and also allows the antenna assembly 400 to be used with different roof curvatures. As shown in FIG. 11, the gaskets 478 include electrically-conductive fingers (e.g., metallic or metal spring fingers, etc.). In an exemplary embodiment, the gaskets comprise fingerstock gaskets from Laird Technologies, Inc.

The antenna assembly 400 may further include other components and features similar or identical in structure and/or operation as the corresponding features of the antenna assembly 100 shown in FIGS. 1 through 3. For example, the antenna assembly 400 includes a chassis 424 and a radome or cover 440. The cover 440 is configured to fit over the first and second cellular antennas 404, 408 and first and second patch antennas 412, 416 such that the antennas 404, 408, 412, 416 are colocated under the cover 440.

The cover 440 is configured to be secured to the chassis 424. In this illustrated embodiment, the cover 440 is secured to the chassis 424 by mechanical fasteners 444 (e.g., screws, etc.). Alternatively, the cover 440 may secure to the chassis 424 via any suitable operation, for example, a snap fit connection, mechanical fasteners (e.g., screws, other fastening devices, etc.), ultrasonic welding, solvent welding, heat staking, latching, bayonet connections, hook connections, integrated fastening features, etc.

The chassis or base 424 may be configured to couple to a roof of a car for installing the antenna assembly 400 to the car. Alternatively, the cover 440 may connect directly to the roof of a car within the scope of the present disclosure.

As shown in FIGS. 9 and 11, the antenna assembly 400 includes a fastener member 446 (e.g., threaded mounting bolt having a hexagonal head, etc.), a first retention component 448 (e.g., an insulator clip, etc.), and a second retention component 450 (e.g., retaining clip, etc.). In a similar manner as that explained above for antenna assembly 100, the fastener member 446 and retention members 448, 450 may be used to mount the antenna assembly 400 to an automobile roof, hood, trunk (e.g., with an unobstructed view overhead or toward the zenith, etc.).

Also shown in FIGS. 9 and 11, the antenna assembly 400 includes a sealing member 452 (e.g., an O-ing, a resiliently compressible elastomeric or foam gasket, a PORON microcellular urethane foam gasket, etc.) that will be positioned between the chassis 424 and the roof of a car (or other mounting surface). The sealing member 452 may substantial seal the chassis 424 against the roof and substantially seal the mounting hole in the roof. The antenna assembly 400 also includes a sealing member 456 (e.g., an O-ring, a resiliently compressible elastomeric or foam gasket, caulk, adhesives, other suitable packing or sealing members, etc.) that is positioned between the radome 440 and the chassis 424 for substantially sealing the radome 440 against the chassis 424. In this example, the sealing member 456 may be at least partially seated within a groove defined along or by the chassis 424. Also in this example, there are sealing members 458, 460 that are positioned between the radome 440 and the roof of the car (or other mounting surface) with the sealing member 458 on top of the sealing member 460. In operation, the sealing members 458, 460 may be operable as seals against dust, etc. and as a shield support. In some embodiments, sealing may be achieved by one or more integral sealing features rather than with a separate sealing mechanism.

The first and second cellular antennas 404, 408 are positioned relatively close to each other. The antenna assembly 400 is preferably configured such that there is sufficient de-correlation (e.g., a correlation less than about 25 percent, etc.), sufficiently low coupling, and sufficient isolation (e.g., at least about 15 decibels, etc.) between the cellular antennas 404, 408. The multiband MIMO antenna assembly 400 is operable over multiple frequency bands, including LTE and others.

The radome 440 includes an opening 470 configured for receiving a lower end portion of an antenna mast (not shown) to allow the antenna mast to be connected or coupled to the first cellular antenna 404. The antenna mast may be configured to be operable over or resonant in multiple frequency bands, such as an amplitude modulation (AM) band, a frequency modulation (FM) band, and/or one or more cellular frequency bands. The antenna mast may be identical to or substantially identical to an antenna mast assembly disclosed in U.S. patent application Ser. No. 13/546,174, the entire contents of which are incorporated herein by reference.

The combination of the antenna mast and antenna assembly 400 provides multiband operation over multiple operating frequencies (e.g., operable and resonant in six or more frequency bands, etc.). For example, the antenna mast and antenna assembly 400 may be configured to be operable over and cover multiple frequency ranges or bands, such as one or more or any combination of the following frequency bands: AM, FM, one or more cellular frequency bands (e.g., LTE 700 MHz, AMPS, GSM850, GSM900, DAB VHF III, PCS, GSM1800, GSM1900, AWS, and UMTS, etc.), global positioning system (GPS), satellite digital audio radio services (SDARS) (e.g., Sirius XM, etc.), Glonass, etc.

In any one or more of the exemplary embodiments disclosed herein, the antenna assembly may include a multiplexer for combining signals (e.g., combining two or more of the communication or cellular signals, GPS signals, and/or satellite signals, etc.) and/or a demultiplexer for demultiplexing combined signals (e.g., combined communication or cellular signals, GPS signals, and/or satellite signals output by a multiplexer, etc.) from the various antenna elements of the antenna assembly. The multiplexer and demultiplexer that may be used in an exemplary embodiment disclosed herein may be identical to or substantially identical to a multiplexer and demultiplexer disclosed in U.S. Pat. No. 8,045,592 and/or U.S. patent application Ser. No. 13/280,327, the entire contents of both of which are incorporated herein by reference.

Numerical dimensions and specific materials disclosed herein are provided for illustrative purposes only. The particular dimensions and specific materials disclosed herein are not intended to limit the scope of the present disclosure, as other embodiments may be sized differently, shaped differently, and/or be formed from different materials and/or processes depending, for example, on the particular application and intended end use.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Disclosure of values and ranges of values (e.g., frequency ranges, etc.) for specific parameters are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A multiband multiple input multiple output (MIMO) vehicular antenna assembly having multiple cellular antennas with low correlation therebetween for receiving communication signals within one or more cellular frequency, the antenna assembly comprising:
a first cellular antenna configured to be operable for receiving and transmitting communication signals within one or more cellular frequency bands;
a second cellular antenna configured to be operable for receiving communication signals within one or more cellular frequency bands; and
one or more satellite antennas configured to be operable for receiving satellite signals.

2. The antenna assembly of claim 1, wherein:
the first cellular antenna is configured to be operable as a primary cellular antenna for both receiving and transmitting communication signals within one or more cellular frequency bands including Long Term Evolution (LTE) frequencies; and
the second cellular antenna is configured to be operable as a secondary cellular antennas for receiving (but not transmitting) communication signals within one or more cellular frequency bands including Long Term Evolution (LTE) frequencies.

3. The antenna assembly of claim 1, wherein:
the first and second cellular antennas are positioned close to each other; and
the antenna assembly is configured such that there is sufficient de-correlation with a correlation less than about 25 percent, sufficiently low coupling, and sufficient isolation of at least about 15 decibels between the first and second cellular antennas despite the close positioning of the first and second cellular antennas.

4. The antenna assembly of claim 1, wherein the first and second cellular antennas and the one or more satellite antennas are colocated on a common chassis under a same radome.

5. The antenna assembly of claim 1, further comprising:
a chassis supporting the first and second cellular antennas and the one or more satellite antennas; and
a radome coupled to the chassis such that the first and second cellular antennas and the one or more satellite antennas are enclosed within an interior space defined by the radome and the chassis.

6. The antenna assembly of claim 5, further comprising a printed circuit board supported by the chassis, and wherein:
the first and second cellular antennas are electrically connected to the printed circuit board;
the first cellular antenna includes one or more bent or formed tabs that provide areas for soldering the first cellular antenna to the printed circuit board; and
the first cellular antenna includes a downwardly extending projection that is at least partially received within a corresponding opening in the printed circuit board to electrical connect to a component on an opposite side of the printed circuit board.

7. The antenna assembly of claim 1, wherein:
the isolation between the first and second cellular antennas is at least 15 decibels; and
the correlation is less than about 25 percent between the first and second cellular antennas; and
whereby the antenna assembly is configured such that the first and second cellular antennas are sufficiently de-correlated to allow the first and second cellular antennas to be positioned relatively close to each other without appreciably degrading performance of the one or more satellite antennas and without considerably increasing an overall size of the antenna assembly by the addition of the second cellular antenna.

8. The antenna assembly of claim 1, wherein:
the isolation between the first and second cellular antennas is at least about 15 decibels;
the correlation is less than about 25 percent between the first and second cellular antennas; and
the antenna assembly has a height of about 66 millimeters and a footprint having a length of about 162 millimeters and a width of about 83 millimeters.

9. The antenna assembly of claim 1, wherein the one or more satellite antennas comprise:
a first patch antenna configured to be operable for receiving satellite digital audio radio services (SDARS) signals; and
a second patch antenna configured to be operable for receiving global positioning system (GPS) signals and/or global navigation satellite (GLONASS) signals.

10. The antenna assembly of claim 1, wherein:
the one or more satellite antennas comprise a first patch antenna and a second patch antenna;
the second cellular antenna includes:
a planar surface having a through hole;
a generally L-shaped extension that defines an opening; and
a downwardly extending portion generally perpendicular to the planar surface and operable for electrically connecting the second cellular antenna to a ground plane;
the first patch antenna is positioned at least partially through the opening of the second cellular antenna;
a first connector extends through the first patch antenna to electrically connect to a first printed circuit board;
the second patch antenna is disposed or mounted on the planar surface of the second cellular antenna; and
a second connector extends through the second patch antenna and the through hole of the second cellular antenna to electrically connect to a second printed circuit board.

11. The antenna assembly of claim 1, wherein:
the first cellular antenna comprises a monopole antenna; and
the second cellular antenna comprises an inverted F antenna, an inverted L antenna, or a planar inverted F antenna.

12. The antenna assembly of claim 1, wherein:
the first cellular antenna comprises a stamped metal wide band monopole antenna mast; and
the second cellular antenna comprises an inverted F antenna and/or stamped and bent sheet metal.

13. The antenna assembly of claim 1, wherein:
the second cellular antenna is supported and held in position by an overmold that comprises a dielectric material overmolded onto the second cellular antenna; and/or
the antenna assembly further comprises one or more foam pads positioned about portions of the first and second cellular antennas to help hold the first and second cellular antennas in place and/or inhibit vibrations during travel of a vehicle to which the antenna assembly is mounted.

14. The antenna assembly of claim 1, further comprising:
an antenna mast operable over multiple frequency bands, including an amplitude modulation (AM) band and a frequency modulation (FM) band; and
a radome under which the first and second cellular antennas and the one or more satellite antennas are positioned, the radome having an opening for receiving a lower end of the antenna mast;
wherein the antenna mast is connected to first cellular antenna and/or the first cellular antenna is further configured to be operable for receiving amplitude modulation (AM) band signals and frequency modulation (FM) band signals.

15. The antenna assembly of claim 1, wherein:
the second cellular antenna is configured to be operable for only receiving, and is inoperable for transmitting, communication signals within one or more cellular frequency bands; and
the antenna assembly is configured to be installed and fixedly mounted to a vehicle body wall after being inserted into a mounting hole in the vehicle body wall from an external side of the vehicle and nipped from an interior compartment side.

16. The antenna assembly of claim 1, wherein:
the first cellular antenna comprises a monopole antenna;
the second cellular antenna comprises an inverted F antenna;
the one or more satellite antennas comprise a first patch antenna configured to be operable for receiving satellite signals, and a second patch antenna configured to be operable for receiving satellite signals different than the satellite signals received by the first patch antenna;
the antenna assembly further comprises a chassis supporting the monopole antenna, the inverted F antenna, and the first and second patch antennas, and a radome coupled to the chassis such that the monopole antenna, the inverted F antenna, and the first and second patch antennas are enclosed within an interior space defined by the radome and the chassis;
the isolation between the first and second cellular antennas is at least about 15 decibels;
the correlation is less than about 25 percent between the first and second cellular antennas; and
the antenna assembly is configured to be installed and fixedly mounted to a vehicle body wall after being inserted into a mounting hole in the vehicle body wall from an external side of the vehicle and nipped from an interior compartment side.

17. A multiband multiple input multiple output (MIMO) vehicular antenna assembly configured to be installed and fixedly mounted to a vehicle body wall after being inserted into a mounting hole in the vehicle body wall from an external side of the vehicle and nipped from an interior compartment side, the antenna assembly comprising:
a primary cellular antenna configured to be operable for receiving and transmitting communication signals within one or more cellular frequency bands;
a secondary cellular antenna configured to be operable for receiving (but not transmitting) communication signals within one or more cellular frequency bands;
a first satellite antenna configured to be operable for receiving satellite signals;
a second satellite antenna configured to be operable for receiving satellite signals different than the satellite signals received by the first satellite antenna;
a chassis; and
a radome coupled to the chassis such that the primary and secondary cellular antennas and the first and second satellite antennas are enclosed within an interior space defined by the radome and the chassis.

18. The antenna assembly of claim 17, wherein:
the primary cellular antenna comprises a monopole antenna that is configured to be operable for both receiving and transmitting communication signals within one or more Long Term Evolution (LTE) frequency bands;
the secondary cellular antenna comprises an inverted F antenna, an inverted L antenna, or a planar inverted F antenna that is configured to be operable as a secondary cellular antennas for receiving (but not transmitting) communication signals within one or more Long Term Evolution (LTE) frequency bands;
the first satellite antenna comprise a first patch antenna configured to be operable for receiving satellite digital audio radio services (SDARS) signals; and
the second satellite antenna comprises a second patch antenna configured to be operable for receiving global positioning system (GPS) signals and/or global navigation satellite (GLONASS) signals;
whereby the antenna assembly is configured such that there a correlation less than about 25 percent, sufficiently low coupling, and sufficient isolation of at least about 15 decibels between the primary and secondary cellular antennas.

19. The antenna assembly of claim 17, wherein:
the secondary cellular antenna includes:
a planar surface having a through hole;
a generally L-shaped extension that defines an opening; and
a downwardly extending portion generally perpendicular to the planar surface and operable for electrically connecting the secondary cellular antenna to a ground plane;
the first satellite antenna comprises a first patch antenna positioned at least partially through the opening of the secondary cellular antenna;
a first connector extends through the first patch antenna to electrically connect to a first printed circuit board;
the second satellite antenna comprises a second patch antenna disposed or mounted on the planar surface of the secondary cellular antenna; and
a second connector extends through the second patch antenna and the through hole of the secondary cellular antenna to electrically connect to a second printed circuit board.

20. A multiband multiple input multiple output (MIMO) vehicular antenna assembly comprising:
a primary cellular monopole antenna that is configured to be operable for both receiving and transmitting communication signals within one or more Long Term Evolution (LTE) frequency bands;
a secondary cellular inverted F antenna configured to be operable for receiving (but not transmitting) communication signals within one or more cellular frequency bands including Long Term Evolution (LTE) frequencies; and;
a first patch antenna configured to be operable for receiving satellite signals;
a second patch antenna configured to be operable for receiving satellite signals different than the satellite signals received by the first patch antenna;
a chassis; and
a radome coupled to the chassis such that the primary cellular monopole antenna, the secondary cellular inverted F antenna, and the first and second patch antennas are enclosed within an interior space defined by the radome and the chassis;
whereby the antenna assembly is configured to have a correlation less than about 25 percent, sufficiently low coupling, and sufficient isolation of at least about 15 decibels between the primary cellular monopole antenna and the secondary cellular inverted F antenna.
